(19) United States
(12) Patent Application Publication
(10) Pub. No.: US 2010/0310971 A1
(43) Pub. Date: Dec. 9, 2010

(54) FUEL CELL MODULE AND CURRENT COLLECTOR THEREOF

(75) Inventors: Wei-Kai Chang, Taoyuan County (TW); Ming-Chou Tsai, Taoyuan County (TW); Chi-Yang Chiu, Taoyuan County (TW); Ching-Sen Yang, Taoyuan County (TW); Chiang-Wen Lai, Taoyuan County (TW)

Correspondence Address: QUINTERO LAW OFFICE, PC, 615 Hampton Dr, Suite A202, Venice, CA, 90291, US

(73) Assignee: NAN YA PCB CORP., Taoyuan County (TW)

(21) Appl. No.: 12/506,886

(22) Filed: Jul. 21, 2009

(30) Foreign Application Priority Data
Jun. 5, 2009 (TW) TW098118674

(51) Int. Cl. H01M 2/02

(52) U.S. Cl. 429/522

(57) ABSTRACT

The invention provides a fuel cell module. The fuel cell module includes a membrane electrode assembly, a flow field plate and a current collector. The current collector, disposed between the membrane electrode assembly and the flow field plate, includes a first surface, a second surface and a plurality of openings. The first surface faces the membrane electrode assembly. The second surface is opposite to the first surface and faces the flow field plate. Each of the openings has an inner wall, and an acute angle is formed between the inner wall and the first surface. Additionally, each opening has a first diameter level with the first surface and a second diameter level with the second surface, wherein the first diameter is smaller than the second diameter.

### CROSS REFERENCE TO RELATED APPILCATIONS

This Application claims priority of Taiwan Patent Application No. 98118674, filed on Jun. 5, 2009, the entirety of which is incorporated by reference herein.

### BACKGROUND OF THE INVENTION

1. Field of the Invention

The invention relates to a fuel cell module, and in particular, to a fuel cell module comprising a current collector, which aids to rapidly exhaust carbon dioxide from the fuel cell.

2. Description of the Related Art

Direct oxidation fuel cells comprise current collectors to collect current produced by anodes and allow carbon dioxide produced by the membrane electrode assemblies (MEA) to exhaust to the anode flow field plate. In detail, fuel enters the anode flow field plate from an end of the fuel cell, and flows through the openings of the current collector to the MEA. The fuel reacts with the anode and produce carbon dioxide in the MEA. Carbon dioxide then flows back to the anode flow field plate through the openings of the current collector, and then out through another end of the fuel cell.

The conventional current collector has a plurality of tiny openings. When carbon dioxide flows through the openings, due to capillary attraction, it easily gets stuck in the openings and is prevented from flowing to the anode flow field plate. Because exhaustion of carbon dioxide indirectly affects fuel cell efficiency, improving flow of carbon dioxide through the openings to the anode flow field plate is desired.

### BRIEF SUMMARY OF THE INVENTION

Accordingly, the invention provides a fuel cell module. The fuel cell module includes a membrane electrode assembly, a flow field plate and a current collector. The current collector, disposed between the membrane electrode assembly and the flow field plate, includes a first surface, a second surface and a plurality of openings. The first surface faces the membrane electrode assembly. The second surface is opposite to the first surface and faces the flow field plate. Each of the openings has an inner wall, and an acute angle is formed between the inner wall and the first surface.

In an embodiment, the current collector includes a first surface, a second surface and a plurality of openings. The second surface is opposite to the first surface and the openings penetrate through the first surface and the second surface. Additionally, each opening has a first diameter level with the first surface and a second diameter level with the second surface, wherein the first diameter is smaller than the second diameter.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is an exploded view of a fuel cell module of the invention;

FIG. 2 is a schematic view of a flow field plate and current collectors of the fuel cell module of the invention;

FIG. 3A is a sectional exploded view showing the flow field plate, the current collectors and the membrane electrode assemblies of the invention; and

FIG. 3B is a sectional view showing the flow field plate, the current collectors and the membrane electrode assemblies of the invention.

### DETAILED DESCRIPTION OF THE INVENTION

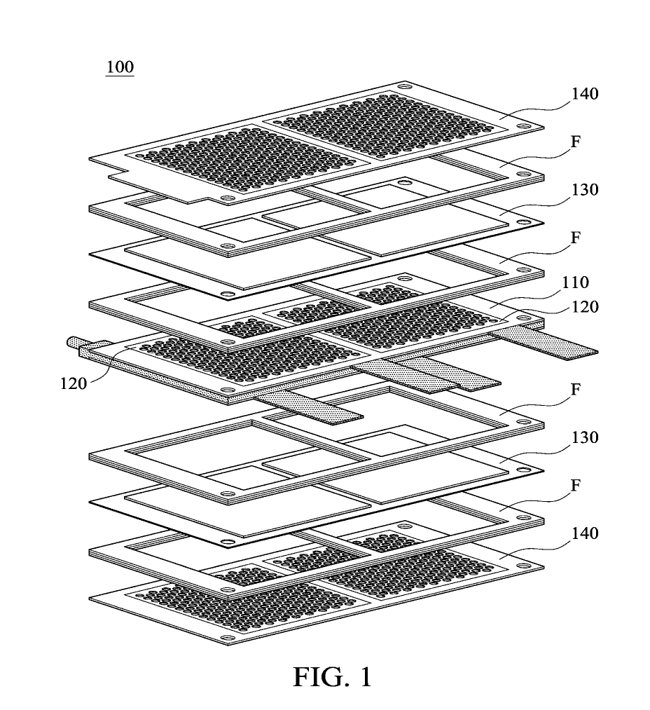

Referring to FIG. 1, the fuel cell module 100 of the invention is a direct oxidation fuel cell (DOFC) module, comprising an anode flow field plate 110, four current collectors 120, two membrane electrode assemblies (MEA) 130 and two cathode plates 140.

Two of the four current collectors 120 are disposed on one side of the anode flow field plate 110, while the other two of the four current collectors 120 are disposed on the other side of the anode flow field plate 110. The two MEAs 130 are disposed on two sides of the anode flow field plates 110, respectively, such that the current collectors 120 are respectively clamped between the anode flow field plate 110 and the two MEAs 130. The two cathode plates 140 are also disposed on two sides of the anode flow field plates 110, respectively, such that the MEAs 130 are clamped between the anode flow field plates 110 and the two cathode plates 140.

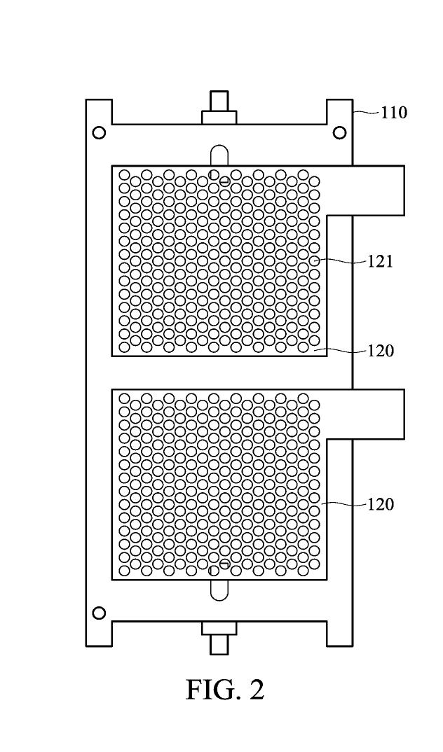

Referring to FIG. 2, the current collectors 120, disposed on the anode flow field plate 110, comprise a plurality of opening 121, wherein the current collectors 120 are made of copper, iron, aluminum, nickel, gold, stainless steel or alloys thereof, and the openings are formed by punching, etching or a computer numerical control process (CNC process). Additionally, the openings 121 are circular-shaped as shown in FIG. 2, or the openings 121 can be rectangular-shaped, S-shaped or other shapes.

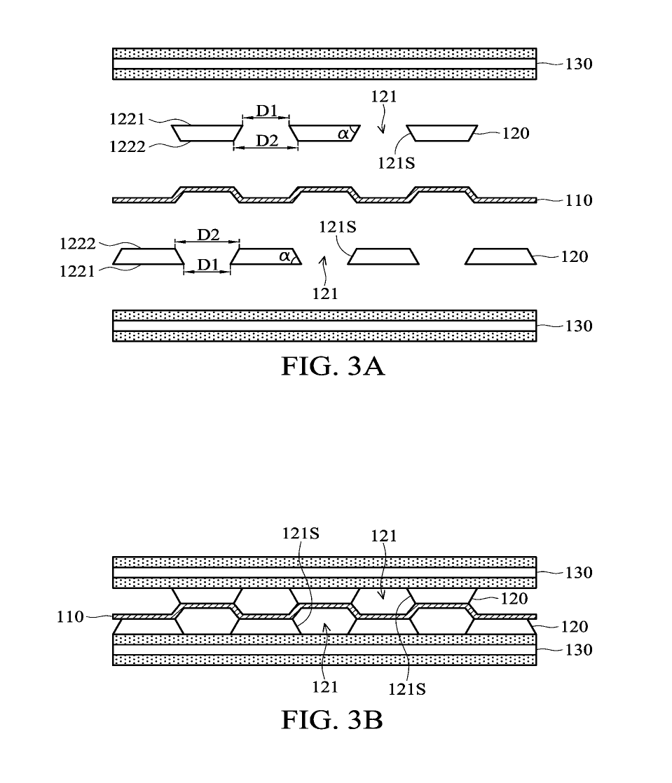

Referring to FIGS. 3A and 3B, each of the current collectors 120 has a first surface 1221 and a second surface 1222, wherein the first surface 1221 is opposite of the second surface 1222. The openings 121 penetrate through the first surface 1221 and the second surface 1222. Each of the openings 121 has a first diameter D1, a second diameter D2 and an inner wall 121S. The first diameter D1 levels with the first surface 1221, and the second diameter D2 levels with the second surface 1222. In addition, the first diameter D1 is smaller than the second diameter D2, such that an acute angle α is formed between the inner wall 121S and the first surface 1221. Preferably, the acute angle α is between 45 degrees and 90 degrees. In the embodiment, the acute angle α is substantially 60 degrees.

As shown in FIGS. 3A and 3B, when the current collectors 120 are clamped between the anode flow field plate 110 and the MEAs 130, the first surface 1221 of the current collectors 120 and the smaller diameter (the first diameter D1) of the openings 121 face the MEAs 130, and the second surface 1222 and the larger diameter (the second diameter D2) of the openings 121 face the anode flow field plate 110. Thereby, carbon dioxide produced in the MEAs 130 is easier to flow through the openings 121 into the anode flow field plate 110, increasing overall efficiency of the fuel cell module 100.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell module, comprising:
a membrane electrode assembly;
a flow field plate; and
a current collector, disposed between the membrane electrode assembly and the flow field plate, comprising:
a first surface facing the membrane electrode assembly;
a second surface opposite to the first surface and facing the flow field plate; and
a plurality of openings, each of the openings having an inner wall;
wherein an acute angle is formed between the inner wall and the first surface.

2. The fuel cell module as claimed in claim 1, wherein the fuel cell module comprises a plurality of current collectors, disposed on two sides of the flow field plate.

3. The fuel cell module as claimed in claim 2, wherein the fuel cell module comprises two membrane electrode assemblies, respectively disposed on two sides of the flow field plate, such that the current collectors are respectively clamped between the flow field plate and the two membrane electrode assemblies.

4. The fuel cell module as claimed in claim 3, further comprising two cathode plates respectively disposed on two sides of the flow field plate, such that the membrane electrode assemblies are respectively clamped between the flow field plate and the two cathode plates.

5. The fuel cell module as claimed in claim 3, wherein the fuel cell module comprises four current collectors, two of the current collectors are disposed on one side of the flow field plate, and the other two of the current collectors are disposed on the other side of the flow field plate.

6. The fuel cell module as claimed in claim 1, wherein the openings are formed by punching, etching or a computer numerical control process (CNC process).

7. The fuel cell module as claimed in claim 1, wherein the openings are circular-shaped, rectangular-shaped or S-shaped.

8. The fuel cell module as claimed in claim 1, wherein the acute angle is between 45 degrees and 90 degrees.

9. The fuel cell module as claimed in claim 1, wherein the current collector is made of copper, iron, aluminum, nickel, gold, stainless steel or alloys thereof.

10. A current collector, having a first surface, a second surface opposite to the first surface, and a plurality of openings, wherein the openings penetrate the first surface and the second surface and each of the openings comprises an inner wall, and an acute angle is formed between the inner wall and the first surface.

11. The current collector as claimed in claim 10, wherein the openings are formed by punching, etching or a computer numerical control process (CNC process).

12. The current collector as claimed in claim 10, wherein the shape of the openings is circular-shaped, rectangular-shaped or S-shaped.

13. The current collector as claimed in claim 10, wherein the acute angle is between 45 degrees and 90 degrees.

14. The current collector as claimed in claim 10, wherein the current collector is made of copper, iron, aluminum, nickel, gold, stainless steel or alloys thereof.

15. A current collector, having a first surface, a second surface opposite to the first surface, and a plurality of openings, wherein the openings penetrate the first surface and the second surface and each of the openings comprises a first diameter level with the first surface and a second diameter level with the second surface, and the first diameter is smaller than the second diameter.

16. The current collector as claimed in claim 15, wherein the openings are formed by punching, etching or a computer numerical control process (CNC process).

17. The current collector as claimed in claim 15, wherein the shape of the openings is circular-shaped, rectangular-shaped or S-shaped.

18. The current collector as claimed in claim 15, wherein the acute angle is between 45 degrees and 90 degrees.

19. The current collector as claimed in claim 15, wherein the current collector is made of copper, iron, aluminum, nickel, gold, stainless steel or alloys thereof.
